(19) United States
(12) Patent Application Publication
(10) Pub. No.: US 2023/0019988 A1
(43) Pub. Date: Jan. 19, 2023

(54) Compositions for Antifouling Protection

(71) Applicants: Takashi NAKAE, Chiba (JP); Paul KAPPOCK, Cumming, GA (US); Yoshiyuki IWASE, Tochigi (JP); Josef SCHROER, Muttenz (CH); Jurgen RIEGLER, Visp (CH); Peter VAN AKEN, Betekom (BE); ARXADA AG, Visp (CH)

(72) Inventors: Takashi Nakae, Chiba (JP); Paul Kappock, Cumming, GA (US); Yoshiyuki Iwase, Tochigi (JP); Josef Schroeer, Muttenz (CH); Jurgen Riegler, Visp (CH); Peter Van Aken, Betekom (BE)

(21) Appl. No.: 17/782,330

(22) PCT Filed: Dec. 4, 2020
(86) PCT No.: PCT/US2020/063193

§ 371 Date: Jun. 3, 2022

(30) Foreign Application Priority Data
Dec. 6, 2019 (EP) 19214311.3

(51) Int. Cl. C09D 133/08; C09D 7/61; C09D 5/14; C09D 5/16

(52) U.S. Cl. CPC C09D 133/08; C09D 7/61; C09D 5/14; C09D 5/1662; C09D 5/1618

(57) ABSTRACT

The present invention relates to antifouling compositions comprising compounds of formula IA and/or IB that are highly effective against marine biofouling of surfaces of ships and marine structures, their use for inhibiting marine biofouling, as well as antifouling paints comprising said compositions.

### FIELD OF THE INVENTION

The present invention relates to antifouling compositions comprising compounds of formula IA and/or IB that are highly effective against marine biofouling of surfaces of ships and marine structures, their use for inhibiting marine biofouling, as well as antifouling paints comprising said compositions.

### BACKGROUND OF THE INVENTION

Ships, aquaculture fishnets, underwater structures and equipment tend to be attacked by marine organisms such as barnacles, bryozoans, hydroids, mussels, algae, and the like. Organisms can grow and multiply and eventually cause significant problems. For example, in the case of a ship's hull, the growth of marine organisms on the hull can increase the frictional resistance between the hull and water, thus increasing fuel consumption and reducing the speed of the ship. Ship hulls need to be protected against the growth of marine organisms in order to keep them clean and smooth for maximum fuel efficiency. There is also a concern for transporting marine organisms from one part of the world to another, with the possibility of the foreign organisms disrupting the indigenous ecology. Thus, adequate protection against marine biofouling is required for underwater parts, which is typically achieved with antifouling paints.

The binder systems used for such antifouling paints are typically composed of an erodible binder. The erosion of the paint film aids in preventing fouling by releasing antifouling agents (biocidal agents) from the coating over time thus impeding the attachment of fouling organisms. There are two main types of eroding antifouling coatings, described by the industry as “self-polishing” and as “ablative”.

The binder system of ablative coatings is composed of mostly rosin which will react with sea water to become water soluble and erodes away. Alternatively, rosin or rosin derivatives are also used in mixtures with non-erodible binders such as polyester resin, acrylic resin, epoxy resin, vinyl chloride resin, chlorinated rubber resin, chlorinated polyethylene resin, chlorinated polypropylene resin, styrene-butadiene resin, or polyamide resin.

In “self-polishing antifouling coatings”, the binder system is based on hydrolysable acrylate polymers. The hydrolysable functionality is commonly provided to the polymer by either a metal carboxylate acrylate monomer or a silyl acrylate monomer. Erodible polyester binders are also used and result in lower cost antifouling paints. The difference between ablative and self-polishing coatings lies mainly in the thickness of the leached layer and the more linear rate of erosion over time for the self-polishing coating.

“Hybrid coatings” also exist whose binder systems are composed of an erodible acrylate such as in self-polishing paints, and rosin. The thickness of the leached layer is thinner than in ablative coatings, but thicker than in true self-polishing coatings.

Most commercially available antifouling paints contain a high metal content due to the high concentration of cuprous oxide (Cu₂O) used as the biocidal agent therein, i.e., typically about 40 wt %, which is required for appropriate antifouling protection. Cuprous oxide is potentially harmful to many organisms. The leaching from antifouling paints can contribute to elevated copper levels in the water, sediments and surrounding environments. Artificial high copper levels may have a significant ecological impact. Whilst Cu₂O is very widely used as antifouling agent in antifouling paints, antifouling paints can also contain additional biocidal agents since Cu₂O alone is only effective against the hard fouling organisms like barnacles.

As an additional disadvantage, cuprous oxide typically imparts a strong red-brown color to the antifouling paint film, and may also react with atmospheric carbon dioxide and chlorides from sea-water to form non-uniform streaking on the surface of the coating. This is an unattractive appearance and may occur, e.g., shortly after the ship is launched into the sea. Some yacht owners and cruise ship operators prefer bright colors and uniform appearance that cannot be attained in paints that contain cuprous oxide.

Attempts to replace cuprous oxide in commercially available antifouling paints led to the development of alternatives to cuprous oxide such as copper thiocyanate, which is white in color, and tralopyril, an agricultural pesticide that has efficacy against barnacles. But the costs are higher for these alternatives and they are not as effective as cuprous oxide based antifouling paints.

Therefore, there is a need for ecologically and economically improved marine antifouling paints with reduced copper content, or that even fully replace the cuprous oxide in conventionally used antifouling paints.

The antifouling compositions of the present invention comprising a compound of formula IA and/or IB fulfill this need. The inventors have surprisingly found that both, the compounds of formula IA and IB are highly effective and versatile agents that enhance the antifouling performance of all types of antifouling paints such as ablative paints or self-polishing paints, and may also be used in simple contact leaching coatings.

Thus, it is now possible to partly or fully replace Cu₂O in antifouling paints and hence to drastically reduce the metal content therein while remaining appropriate antifouling performance. Moreover, the antifouling compositions of the invention comprising a compound of formula IA and/or IB are essentially colorless and hence do not interfere with the bright colors oftentimes desired for ship hulls.

### BRIEF DESCRIPTION OF THE FIGURES

FIG. 1 depicts panels coated with antifouling paints of example 2, Table 1, and shows the appearance of the panels after 6 months in sea-water (Himeji, depth: 1.5 m). The black square indicates the region for negative control, i.e., coating without any antifouling ingredient.

FIG. 2 depicts panels coated with the antifouling paints of example 2, Table 2, and shows the appearance of the panels after 4 months in sea-water (Himeji, Nagasaki and Onagawa). Panel 6 of the “Nagasaki” trial and the Himeji trial, respectively, show the panel after 1 month in the sea water. Panel 6 of the “Onagawa” trial shows the panel after 4 month in the sea water.

FIG. 3 depicts panels coated with the antifouling paints of example 2, Table 3, and shows the appearance of the panels after 1 months in sea-water (Nagasaki; depth: 1.5 m). The black squares indicate the region for negative control, i.e., coating without any antifouling ingredient.

### DETAILED DESCRIPTION OF THE INVENTION

Unless defined otherwise, all technical and scientific terms used herein have the same meaning as commonly understood by one of ordinary skill in the art to which this invention is related. The following abbreviations and terms are used herein:

AIBN: azobis(isobutyronitril)
AMBN: azobis-(2-methylbutyronitrile)
A630-20X: a fatty acid amide
BA: butyl acrylate
Chlorothalonil: 2,4,5,6-tetrachlorobenzene-1,3-dicarbonitrile
Copper Omadine®, CuPT, copper pyrithione: copper 2-pyridinethiol-1-oxide
Cu₂O: cuprous oxide
CuSCN: copper(I) thiocyanate
DCOIT: 4,5-dichloro-2-n-octyl-4-isothiazolin-3-one
Diuron: 3-(3,4-dichlorophenyl)-1,1-dimethylurea
Disparlon A650-20x: Synthetic polyamide wax dispersion. Acts as a superior anti-settling agent for
heavy pigments and metallics. Possesses highly shear thinning resulting in superior application
properties.
ETFAA: ethyl 4,4,4-trifluoroacetoacetate
Laroflex® MP 25: copolymer of vinyl chloride and vinyl isobutyl ether
2MEA: 2-methoxyethyl acrylate monomer
Medetomidine: 4-[1-(2,3-dimethylphenyl)ethyl]-1H-imidazole
MMA: methyl methacrylate monomer
MIBK: methyl isobutylketone
MPM: methoxy propylene monomer
PGM: propylene glycol monomethylether
TIPX: tri-isopropylsilyl acrylate monomer
Tralopyril: 4-bromo-2-(4-chlorophenyl)-5-(trifluoromethyl)-1H-pyrrole-3-carbonitrile
VAGH: vinyl chloride/vinyl acetate/vinyl alcohol copolymer (commercial product)
Zineb: zinc ethane-1,2-diylbis(dithiocarbamate)
Ziram: zinc N,N-dimethylcarbamodithioate
Zn(ETFAA)₂: zinc di(ethyl 4,4,4-trifluoroacetoacetate), also referred to herein as ZnETFAA
ZnO: zinc oxide
ZnPT: zinc pyrithione: zinc 2-pyridinethiol-1-oxide

The term “(meth)acrylate” is a collective term indicating both acrylate and methacrylate monomers. The term “methacrylate” or “meth-acrylate” indicates only methacrylate monomers.

Bentone SD2 is an organo clay added for anti-settling properties; Bentone #38 is quaternium 18-hectorite clay; Minex 4 is nepheline syenite clay. Disparlon 6900-20x (A630-20X polyamide wax) is a 20% dispersion of polyamide wax in xylene used as rheology modifier; Disperbyk 161 is a dispersing additive. Resin refers to all pre-polymers or polymers that may serve as raw materials for the binders to be used in the antifouling paints of the invention. Rosin or gum rosin refers to colophony (CAS: 8050-09-7, see also https://www.megaglori.com/what-is-gum-rosin/).

By “biocidal agent” is meant any chemical compound that prevents the settlement of marine organisms on a surface and/or prevents the growth of marine organisms on a surface and/or encourages the dislodgement of marine organisms from a surface.

The terms “antifouling paint”, “antifouling coating” and “antifouling formulation” are used interchangeably herein.

The present invention provides a new approach to inhibit the fouling of surfaces of underwater objects such as ship hulls or any other marine structures. Specifically, the present invention provides an antifouling composition comprising a compound of formula IA and/or IB

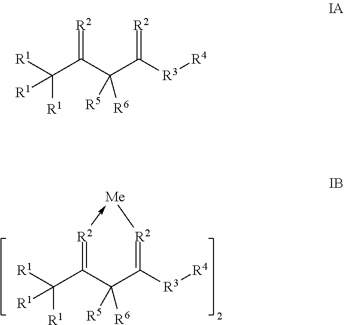

wherein
Me represents metal, preferably Cu, Zn, Co, Ni, Ca, Mg or Mn;
R1 may be any functionality that brings high hydrophobicity, for example,
R1 is each independently selected from hydrogen, halogen, linear or branched C₁₋₂₀ alkyl, C₂₋₂₀ alkenyl, C₂₋₂₀ alkynyl, C₃₋₁₂ cycloalkyl, C₅₋₂₀ aryl and C₇₋₂₀ arylalkyl;
R2 is each independently selected from NH, O, S, and Se;

### R3 is NH, N(R4), O, S, and Se;

R4 is hydrogen, linear or branched C₁₋₂₀ alkyl, C₂₋₂₀ alkenyl, C₂₋₂₀ alkynyl, C₃₋₁₂ cycloalkyl, C₆₋₂₀ aryl, C₇₋₂₀ arylalkyl;
R5 and R6 are each independently selected from H, linear or branched C₁₋₂₀ alkyl, C₂₋₂₀ alkenyl, C₂₋₂₀ alkynyl, C₃₋₁₂ cycloalkyl, C₆₋₂₀ aryl and C₇₋₂₀ arylalkyl; or
R5 and R6 together form a group ═O, ═S, ═Se, ═NR4, ═C(R4)₂, ═C(R4)(OR4), ═C(R4)(NHR4).

In one embodiment, the present invention provides an antifouling composition comprising a compound of formula IA and/or IB as depicted above wherein

Me represents Cu, Zn, Ca, Mg or Mn;
R1 is each independently selected from H, F, C₁, Br, I, linear or branched C₁₋₁₂ alkyl, C₂₋₁₂ alkenyl, C₂₋₁₂ alkynyl, C₆₋₁₂ aryl, and C₇₋₁₂ arylalkyl;
R2 is each independently selected from NH, O, and S;

### R3 is NH, N(R4), 0, and S;

R4 is H, linear or branched C₁₋₁₂ alkyl, C₂₋₁₂ alkenyl, C₂₋₁₂ alkynyl, C₃₋₈ cycloalkyl, C₆₋₁₂ aryl, C₇₋₁₂ arylalkyl;
R5 and R6 are each independently selected from H, linear or branched C₁₋₄ alkyl, C₂₋₄ alkenyl, C₂₋₄ alkynyl, C₃₋₆ cycloalkyl, C₆₋₁₂ aryl and C₇₋₁₂ arylalkyl; or
R5 and R6 together form a group ═O, ═S, ═NR4, ═C(R4)₂, ═C(R4)(OR4), ═C(R4)(NHR4).

In one embodiment, the present invention provides an antifouling composition comprising a compound of formula IA and/or IB as depicted above wherein

Me represents Cu or Zn;
R1 is each independently selected from H, F, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂alkyl, and benzyl;
R2 is each independently selected from NH, and O;
R3 is N(R4) and O; R4 is H, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, and benzyl;
R5 and R6 are each independently selected from H, methyl, ethyl, n-propyl, i-propyl, n-butyl, i-butyl, tert-butyl, and benzyl; or
R5 and R6 together form a group ═CH(OCH₃); ═CH(OC₂H₅); ═CH(OnC₃H₇); ═CH(OiC₃H₇); ═CH(OnC₄H₉); ═CH(OiC₄H₉); ═CH(Otert.C₄H₉), ═CH(NHCH₃); ═CH(NHC₂H₆); ═CH(NHnC₃H₇); ═CH(NHiC₃H₇); ═CH(NHnC₄H₉); ═CH(NHiC₄H₉); ═CH(NHtert.C₄H₉).

In one embodiment, the present invention provides an antifouling composition comprising a compound of formula IA and/or IB as depicted above wherein

Me represents Cu or Zn;
R1 is each independently selected from H and F;
R2 is each independently selected from NH, and O;
R3 is N(CH₃), N(C₂H₆) and O;
R4 is H, methyl, ethyl, n-propyl, i-propyl, n-butyl, i-butyl, tert.-butyl, C₈ alkyl, C₉ alkyl, C₁₀ alkyl, C₁₁ alkyl, C₁₂ alkyl, and benzyl;
R5 and R6 are each H; or
R5 and R6 together form a group ═CH(OCH₃); ═CH(OC₂H₆), ═CH(NHCH₃); ═CH(NHC₂H₆);

In one embodiment, the compound of formula IB is as defined above with the proviso that if Me is Cu, each R1 is F, each R2 is O, R3 is O, and R5 and R6 are each H, then R4 is not ethyl.

Suitable compounds of formula IA and IB, respectively, are, for example
Ethyl 3-amino-4, 4, 4-trifluorocrotonate;
[Ethyl 3-amino-4, 4, 4-trifluorocrotonate]₂Zn,
[Ethyl 3-amino-4, 4, 4-trifluorocrotonate]₂Cu,
Ethyl 3-amino-2-methylene-(methylamino)-4, 4-difluorocrotonate,
[Ethyl 3-amino-2-methylene-(methylamino)-4, 4-difluorocrotonate]₂Zn,
[Ethyl 3-amino-2-methylene-(methylamino)-4, 4-difluorocrotonate]₂Cu
4, 4, 4-Trifluoro-N, N-dimethyl-3-oxobutanamide;
[4, 4, 4-Trifluoro-N, N-dimethyl-3-oxobutanamide]₂Cu,
[4, 4, 4-Trifluoro-N, N-dimethyl-3-oxobutanamide]₂Zn,
Dodecyl 4, 4, 4-trifluoro-3-oxobutanoate,
[Dodecyl 4, 4, 4-trifluoro-3-oxobutanoate]₂Zn,
Dodecyl 4, 4, 4-trifluoro-3-oxobutanoate]₂Cu,
Benzyl 4, 4, 4-trifluoroacetoacetate,
[Benzyl 4, 4, 4-trifluoroacetoacetate]₂Zn,
[Benzyl 4, 4, 4-trifluoroacetoacetate]₂Cu,
Octyl 4, 4, 4-trifluoroacetoacetate,
[Octyl 4, 4, 4-trifluoroacetoacetate]₂Zn,
[Octyl 4, 4, 4-trifluoroacetoacetate]₂Cu,
Isopropyl 4, 4, 4-trifluoroacetoacetate,
[Isopropyl 4, 4, 4-trifluoroacetoacetate]₂Zn,
[Isopropyl 4, 4, 4-trifluoroacetoacetate]₂Cu,
Ethyl 4,4,4-trifluoroacetoacetate,
[Ethyl 4,4,4-trifluoroacetoacetate]₂Zn
Tert-Butyl 4, 4, 4-trifluoro-3-oxobutanoate,
[Tert-Butyl 4, 4, 4-trifluoro-3-oxobutanoate]₂Zn,
[Tert-Butyl 4, 4, 4-trifluoro-3-oxobutanoate]₂Cu

In some embodiments, the antifouling composition comprises a compound of formula IA or IB as defined above. In some embodiments, the antifouling composition comprises a compound of formula IA and IB as defined above.

It has been surprisingly found that compounds of formula IA and IB significantly enhance the antifouling efficacy of antifouling compositions against the settling of marine organisms such as barnacles, bryozoans, hydroids, mussles, algae and the like.

The antifouling composition of the invention may further comprise one or more biocidal agents capable of preventing the fouling on the surface of an object.

Such biocidal agents may be inorganic biocidal agents, organometallic biocidal agents or organic biocidal agents.

Examples of inorganic biocidal agents are copper and copper compounds such as copper oxides, e.g. cuprous oxide and cupric oxide; copper alloys, e.g. copper-nickel alloys; copper salts, e.g. copper thiocyanate (CuSCN), copper sulphide; or barium metaborate.

Examples of organometallic biocidal agents are zinc 2-pyridinethiol-1-oxide [ZnPT, zinc pyrithione]; organo-copper compounds such as copper 2-pyridinethiol-1-oxide [CuPT, copper pyrithione], copper acetate, copper naphthenate, copper 8-uinolinonate [oxine-copper], copper nonylphenolsulfonate, copper bis(ethylenediamine)bis (dodecylbenzensulfonate) and copper bis(pentachlorophenolate); dithiocarbamate compounds such as zinc N,N-dimethylcarbamodithioate [ziram], zinc ethane-1,2-diylbis(dithiocarbamate) [zineb], manganese ethylenebis(dithiocarbamate) [maneb] or manganese ethylenebis(dithiocarbamate) complexed with zinc salt [mancozeb].

Examples of organic biocidal agents are heterocyclic compounds such as 2-(tert-butylamino)-4-(cyclopropylamin)-6-(methylthio)-1,3,5-triazine [cybutryne], 4,5-dichloro-2-n-octyl-4-isothiazolin-3-one [DCOIT], 1,2-benzisothiazolin-3-one [BIT], 2-(thiocyanatomethylthio)-1,3-benzothiazole [benthiazole], 3-benzo[b]thien-2-yl-5,6-dihydro-1,4,2-oxathiazine-4-oxide [bethoxazin] and 2,3,5,6-tetrachloro-4-(methylsulphonyl)pyridine; urea derivatives such as 3-(3,4-dichlorophenyl)-1,1-dimethylurea [diuron]; amides and imides of carboxylic acids, sulphonic acids and sulphenic acids such as N-(dichlorofluoromethylthio)phthalimide, N-dichlorofluoromethylthio-N′,N′-dimethyi-N-phenylsulfamide [dichlofluanid], N-dichlorofluoromethylthio-N′,N′-dimethyl-N-p-tolylsulfamide [tolylfluanid] and N-(2,4,6-trichlorophenyl) maleimide; other organic compounds such as pyridine triphenylborane, amine triphenylborane, 3-iodo-2-propynyl-N-butylcarbamate [iodocarb], 2,4,5,6-tetrachloroisophthalonitrile [chlorothalonil], p-((diiodomethyl)sulphonyl) toluene or 4-bromo-2-(4-chlorophenyl)-5-(trifluoromethyl)-1H-pyrrole-3-carbonitrile [tralopyril].

Other examples of biocidal agents are tetra-alkylphosphonium halogenides, guanidine derivatives, imidazole containing compounds such as 4-[1-(2,3-dimethylphenyl)ethyl]-1H-imidazole [medetomidine] and derivatives, macrocyclic lactones including avermectins and derivatives thereof such as ivermectine, or spinosyns and derivatives thereof such as spinosad, or enzymes such as oxidase, or proteolytically, hemicellulolytically, cellulolytically, lipolytically or amylolytically active enzymes.

In one embodiment, the antifouling composition of the invention comprises a compound of formula IA and/or IB as defined above and further one or more biocidal agents selected from the group consisting of copper 2-pyridinethiol-1-oxide (CuPT, copper pyrithione), zinc 2-pyridinethiol-1-oxide (ZnPT, zinc pyrithione), 4,5-dichloro-2-n-octyl-4-isothiazolin-3-one (DCOIT), cuprous oxide (Cu₂O), zinc oxide (ZnO), 4-bromo-2-(4-chlorophenyl)-5-(trifluoromethyl)-1H-pyrrole-3-carbonitrile (tralopyril), zinc ethane-1,2-diylbis(dithiocarbamate) (zineb), zinc N,N-dimethylcarbamodithioate (ziram), 3-(3,4-dichlorophenyl)-1,1-dimethylurea (diuron), copper(I) thiocyanate (CuSCN), 4-[1-(2,3-dimethylphenyl)ethyl]-1H-imidazole (medetomidine), triazines, fluanids and 2,4,5,6-tetrachloroisophthalonitrile (chlorothalonil).

In a preferred embodiment, the antifouling composition of the invention comprises a compound of formula IA and/or IB as defined above and one or more biocidal agents selected from the group consisting of CuPT, ZnPT, DCOIT, Cu₂O and tralopyril.

In a more preferred embodiment, the antifouling composition of the invention comprises a compound of formula IA and/or IB as defined above and one or more biocidal agent selected from the group consisting of CuPT and Cu₂O. The ratio of said compound of formula IA and/or IB (wt %) to CuPT (wt %) and/or the ratio of said compound of formula IA and/or IB (wt %) to Cu₂O (wt %) is advantageously from 100:1 to 1:100, preferably from 15:1 to 1:15, and most preferably from 5:1 to 1:5.

In a specific embodiment, the antifouling composition of the invention comprises said compound of formula IA and/or IB and CuPT. The ratio of said compound of formula IA and/or IB (wt %) to CuPT (wt %) is advantageously from 100:1 to 1:100, preferably from 10:1 to 1:10, and most preferably from 5:1 to 1:5.

In another specific embodiment, the antifouling composition of the invention comprises said compound of formula IA and/or IB and Cu₂O. The ratio of said compound of formula IA and/or IB (wt %) to Cu₂O (wt %) is advantageously from 100:1 to 1:100, preferably from 10:1 to 1:10, and most preferably from 5:1 to 1:5.

In a more specific embodiment, the antifouling composition of the invention comprises said compound of formula IA and/or IB, CuPT and Cu₂O, wherein the ratio of said compound of formula IA and/or IB (wt %) to CuPT (wt %) is from 5:1 to 5:1, and wherein the ratio of said compound of formula IA and/or IB (wt %) to Cu₂O (wt %) is 5:1 to 1:5.

In another specific embodiment, the antifouling composition of the invention comprises said compound of formula IA and/or IB and CuPT and is free of Cu₂O, wherein the ratio of said compound of formula IA and/or IB (wt %) to CuPT (wt %) is from 5:1 to 5:1.

The antifouling compositions of the invention comprising a compound of formula IA and/or IB as defined above not only provide excellent antifouling properties, but are also essentially colorless and hence do not interfere with the bright colors oftentimes desired for ship hulls.

The present invention further provides the use of the antifouling compositions of the invention for the inhibition of marine biofouling on a solid surface. The solid surface may be any solid surface of underwater objects such as ships, an aquaculture fishnet, an underwater structure and equipment, a tank, an offshore construction, a pipe, a net, a pier, a pile or a pillar or the like.

The antifouling compositions of the invention may further be used in combination with a polymer and/or copolymer allowing the controlled release of said compound of formula IA and/or IB, and if present also the controlled release of said one or more biocidal agents comprised therein, e.g., by releasing these agents from an antifouling coating over time as is the case with self-polishing or ablative coatings.

The inventors have surprisingly found that compounds of formula IA and/or IB is are versatile agents that may be used in all types of antifouling coatings, i.e., in antifouling coatings based on various different polymers and/or copolymers typically used as binders for antifouling coating compositions. Thus, the polymers and/or copolymers allowing the controlled release of said compound of formula IA and/or IB, and if present also the controlled release of said one or more biocidal agents comprised therein, may be any polymers and/or copolymers typically used as binder in antifouling coatings. Suitable polymers and/or copolymers for that purpose are known to the person skilled in the art. Depending on the amount and kind of binder used, said compound of formula IA and/or IB and the one or more biocidal agents will be released in a controlled manner at a predetermined desired rate, e.g., that is appropriate for the sailing pattern of a ship.

For example, the polymers and/or copolymers that are used as binders in “self-polishing antifouling coatings” allowing the controlled release of said compound of formula IA and/or IB and said one or more biocidal agents may be hydrolysable acrylate polymers such as (meth)acrylate based polymers and/or copolymers. The (meth)acrylate monomer moiety in a (meth)acrylate polymer and/or copolymer may be an alkyl (meth)acrylate, for example a methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, pentyl (meth)acrylate, hexyl (meth)acrylate, heptyl (meth)acrylate, cyclohexyl (meth)acrylate, octyl (meth)acrylate, iso-octyl (meth)acrylate, 2-ethylhexyl (meth)acrylate, 3,5,5-trimethylhexyl (meth)acrylate, lauryl (meth)acrylate, cetyl (meth)acrylate and stearyl (meth)acrylate; but also phenyl (meth)acrylate; benzyl (meth)acrylate; or an alkoxyalkyl (meth)acrylate such as methoxymethyl (meth)acrylate, 2-methoxyethyl (meth)acrylate, ethoxymethyl (meth)acrylate, 2-ethoxyethyl (meth)acrylate, 4-methoxybutyl (meth)acrylate, methoxypropyl (meth)acrylate, ethoxypropyl (meth)acrylate, propoxyethyl (meth)acrylate, 2-butoxyethyl (meth)acrylate, isobutoxybutyl diglycol (meth)acrylate; but also a phenoxyethyl (meth)acrylate; or a hydroxyalkyl (meth)acrylate such as hydroxymethyl (meth)acrylate, 2-hydroxyethyl (meth)acrylate, 2-hydroxypropyl (meth)acrylate, 4-hydroxybutyl (meth)acrylate or 2-hydroxy-3-phenoxypropyl (meth)acrylate;

the (meth)acrylate monomer moiety in a (meth)acrylate polymer and/or copolymer may further be a silyl (meth)acrylate such as tribenzylsilyl (meth)acrylate, trimethylsilyl (meth)acrylate, triethylsilyl (meth)acrylate, tri-isopropylsilyl (meth)acrylate, tri-n-butylsilyl (meth)acrylate, tri-isobutylsilyl (meth)acrylate, tri-t-butylsilyl (meth)acrylate, tri-n-amylsilyl (meth)acrylate, tri-n-dodecylsilyl (meth)acrylate, tri-n-hexylsilyl (meth)acrylate, tri-n-octylsilyl (meth)acrylate, tri-n-propylsilyl (meth)acrylate or triphenylsilyl (meth)acrylate;
the (meth)acrylate polymers and/or copolymers may also comprise a metal salt moiety of acrylic or methacrylic acid, referred to herein as a “metal salt (meth)acrylate”. The metal may be any suitable metal known to the skilled artisan, e.g., zinc, calcium, magnesium, lithium, iron, zirconium, aluminum, cobalt, zirconium, barium and bismuth.

The polymer and/or copolymer allowing the controlled release of said compound of formula IA and/or IB and if present also the controlled release of said one or more biocidal agents, may also be a VAGH copolymer. The VAGH copolymer may be dissolved in 2:3 xylene:MIBK.

Thus, in one embodiment, the polymer and/or copolymer allowing the controlled release of said compound of formula IA and/or IB and if present also the controlled release of said one or more biocidal agents comprises a (meth)acrylate polymer and/or copolymer, or a VAGH copolymer. The (meth)acrylate polymer and/or copolymer may be a polymer or copolymer of monomer moieties selected from the group consisting of alkyl (meth)acrylate, phenyl (meth)acrylate, benzyl (meth)acrylate, alkoxyalkyl (meth)acrylate, hydroxyalkyl (meth)acrylate, zinc (meth)acrylates, and silyl-(meth)acrylate; or the (meth)acrylate polymer and/or copolymer may be a polymer or copolymer of monomer moieties selected from the group consisting of ethyl acrylate, methyl methacrylate, butyl acrylate, 2-methoxyethyl acrylate, zinc methacrylate, and tri-isopropylsilyl acrylate, preferably, the (meth)acrylate polymer and/or copolymer is a copolymer of monomer moieties selected from the group consisting of ethyl acrylate, methyl methacrylate, and zinc methacrylate, more preferably, the (meth)acrylate polymer polymer and/or copolymer is a copolymer of monomer moieties selected from the group consisting of ethyl acrylate, methyl methacrylate, 2-methoxyethyl acrylate and zinc methacrylate, and most preferably, the (meth)acrylate polymer polymer and/or copolymer is a copolymer of monomer moieties selected from the group consisting of methyl methacrylate, butyl acrylate, 2-methoxyethyl acrylate and tri-isopropylsilyl acrylate.

Consequently, the invention further provides an antifouling paint comprising the antifouling composition of the invention and a polymer and/or copolymer allowing the controlled release of said compound of formula IA and/or IB and if present also the controlled release of said one or more biocidal agents.

The content of said compound of formula IA and/or IB in the antifouling paint of the invention is from about 1 to about 25 wt %, preferably from about 3 to about 20 wt %, and more preferably from about 4 to about 18 wt %, and most preferably from about 5 to about 15 wt %.

Due to the excellent enhancing properties of said compound of formula IA and/or IB only low amounts of said one or more biocidal agents are required in the antifouling paint of the invention. The total content of the one or more biocidal agents in the antifouling paint of the invention is less than about 30 wt %, preferably less than about 25 wt %, more preferably less than about 20 wt %, and most preferably less than about 18 wt %.

The total content of CuPT in the antifouling paint of the invention is less than about 10 wt %, more preferably less than about 8 wt %, and most preferably less than about 7 wt %.

The total content of Cu₂O in the antifouling paint of the invention is less than about 20 wt %, more preferably less than about 15 wt %, and most preferably less than about 12 wt %.

Thus, the content of toxic metal compounds, in particular of Cu₂O, is kept at a very low level, and can even be avoided.

The present invention further provides a method for inhibiting marine biofouling on a solid surface, characterized in that an antifouling paint comprising the antifouling composition of the invention is applied on said surface. The solid surface may be any solid surface of underwater objects such as ships, an aquaculture fishnet, an underwater structure and equipment, a tank, an offshore construction, a pipe, a net, a pier, a pile or a pillar and the like.

In the following, the present invention will be further described with reference to Examples, but should be construed that the present invention is in no way limited to these Examples.

### EXAMPLES

### Example 1: Preparation of Exemplary Polymer-Based Binders for Antifouling Paints

Different exemplary polymer-based binders that can be used in self-polishing antifouling paints or hybrid coatings have been prepared as outlined in the following.

Example 1A: Synthesis of an acrylate polymer “Acid acrylate low acid value” referred to herein as “Ac (AV=100-)”

| Description | Quantity (g) | Weight (%) |
|---|---|---|
| MPM | 355.03 | 11.83 |
| Xylene | 671.01 | 22.37 |
| ethyl acrylate | 56.8 | 1.89 |

bring to 100° C. while mixing and drop into the following mixture
over 6 hours

| | | |
|---|---|---|
| methyl methacrylate | 213.02 | 7.1 |
| ethyl acrylate | 1009.47 | 33.65 |
| methacrylic acid | 149.11 | 4.97 |
| Xylene | 147.93 | 4.93 |
| Methyl Styrene Dimer | 14.2 | 0.47 |
| AIBN | 35.5 | 1.18 |
| AMBN | 99.41 | 3.31 |

add chaser and xylene over ½ hour

| | | |
|---|---|---|
| t-butylperoxy 2-ethylhexyl carbonate | 7.1 | 0.24 |
| Xylene | 143.2 | 4.77 |

mix for 90 minutes after chaser is in. Cool down and add

| | | |
|---|---|---|
| Xylene | 98.22 | 3.27 |
| Total | 3000 | 100 |
| Manual Yield % | 100 | |
| Net | 3000 | |

Example 1B: Synthesis of an acrylate polymer “Acid acrylate 100 acid value” referred to herein as “Ac (AV=100)”

| Description | Quantity (g) | Weight (%) |
|---|---|---|
| MPM | 355.5 | 11.85 |
| Xylene | 668.4 | 22.28 |
| ethyl acrylate | 56.7 | 1.89 |

bring to 100° C. while mixing and drop into the following mixture
over 6 hours

| | | |
|---|---|---|
| methyl methacrylate | 142.2 | 4.74 |
| ethyl acrylate | 867.3 | 28.91 |
| methacrylic acid | 142.2 | 4.74 |
| 2-methoxyethyl acrylate | 213.6 | 7.12 |
| Xylene | 142.2 | 4.74 |
| Methyl Styrene Dimer | 14.1 | 0.47 |
| AIBN | 35.4 | 1.18 |
| AMBN | 99.3 | 3.31 |

add chaser and xylene over ½ hour

| | | |
|---|---|---|
| t-butylperoxy 2-ethylhexyl carbonate | 7.2 | 0.24 |
| Xylene | 142.2 | 4.74 |

mix for 90 minutes after chaser is in. Cool down and add

| | | |
|---|---|---|
| Xylene | 113.7 | 3.79 |
| Total | 3000 | 100 |
| Manual Yield % | 100 | |
| Net | 3000 | |

Example 1C: Synthesis of a binder component using the acrylate polymer “Ac (AV=100-)” to give a zinc acrylate polymer referred to herein as “Zn—Ac (AV=100-)”

| Description | Quantity (g) | Weight (%) |
|---|---|---|
| Ac (AV = 100−) | 3000 | 82.395 |
| Zinc Oxide | 81 | 2.225 |
| zinc naphthenate | 560 | 15.38 |

Mix for 6 hours at 100° C. and add 20 g water if ZnO is not dissolved
after 6 hours

| | | |
|---|---|---|
| Total | 3641 | 100 |
| Manual Yield % | 100 | |
| Net | 3641 | |

### Example 1D: Synthesis of a binder component using the acrylate polymer “Ac (AV=100)” to give a

zinc acrylate polymer referred to herein as “Zn—Ac (AV=100)”

| Description | Quantity (g) | Weight (%) |
|---|---|---|
| Ac (AV = 100) | 3000 | 75.82 |
| Zinc Oxide | 106.5 | 2.69 |
| zinc naphthenate | 850 | 21.48 |

Mix for 6 hours at 100° C. and add 20 g water if ZnO is not dissolved
after 6 hours

| | | |
|---|---|---|
| Total | 3956.5 | 100 |
| Manual Yield % | 100 | |
| Net | 3956.5 | |

Example 1E: Synthesis of a silyl acrylate polymer standard TIPX binder component referred to herein as “Si—Ac”

| Description | Quantity (g) | Weight (%) |
|---|---|---|
| Xylene | 1826 | 45.65 |

add the following monomer mixture dropwise over 3 hours at 90° C.

| | | |
|---|---|---|
| methyl methacrylate | 665.4 | 16.64 |
| butyl acrylate monomer | 228 | 5.7 |
| 2-methoxyethyl acrylate | 99.2 | 2.48 |
| trisopropysilyl acrylate monomer (TIPX) | 992.4 | 24.81 |
| AIBN | 20 | 0.5 |

after all monomer added, mix for additional 2 hours at 90° C., then add

| | | |
|---|---|---|
| t-butylperoxy 2-ethylhexyl carbonate | 10 | 0.25 |
| Xylene | 159 | 3.98 |

drop xylene mixture over ½ hour at 90° C., then mix another 1 hour
before cooling down

| | | |
|---|---|---|
| Total | 4000 | 100 |
| Manual Yield % | 100 | |
| Net | 4000 | |

Example 1F: Synthesis of silyl acrylate polymer lower TIPX binder component referred to herein as “Si—Ac (TIPX-L)”

| Description | Quantity (g) | Weight (%) |
|---|---|---|
| Xylene | 1826 | 45.65 |

add the following monomer mixture dropwise over 3 hours at 90° C.

| | | |
|---|---|---|
| methyl methacrylate | 912 | 22.8 |
| butyl acrylate monomer | 310 | 7.75 |
| 2-methoxyethyl acrylate | 60 | 1.5 |
| trisopropysilyl acrylate monomer | 703 | 17.58 |
| AIBN | 20 | 0.5 |

after all monomer added, mix for additional 2 hours at 90° C., then add

| | | |
|---|---|---|
| t-butylperoxy 2-ethylhexyl carbonate | 10 | 0.25 |
| Xylene | 159 | 3.98 |
| Total | 4000 | 100 |
| Manual Yield % | 100 | |
| Net | 4000 | |

### Example 2: Potency of Cu₂O and Compounds of the Invention in Antifouling Paints

In order to confirm that the amount of Cu₂O can be significantly reduced if a compound of formula IA or IB of the invention is present in antifouling paints, the efficacy of a set of ablative antifouling paints was evaluated by immersing experimental painted panels in seawater on a test raft.

Various ablative antifouling paints have been prepared for this purpose containing a) only a compound IA or IB of the invention (i.e., without a biocidal agent), b) a compound IA or IB of the invention together with a biocidal agent (i.e., Cu₂O), c) only biocidal agent (i.e., Cu₂O, or Cu₂O together with CuPT, respectively, as “positive control paints”), and d) without biocidal agent and without compound IA or IB (“negative control paint”).

The compounds of the invention employed in this example are depicted in Table 1 below. The detailed formulations of the paints are depicted in Tables 2 to 4 below. The paints have been applied to PVC panels as follows.

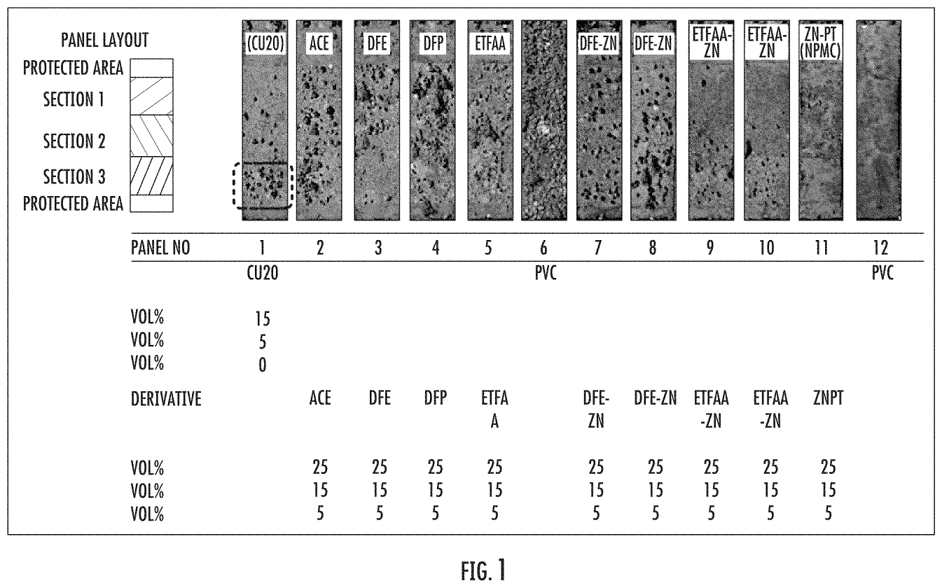

Each panel was divided into three sections and coated with the respective paints (i.e., containing either the biocide, or the compound of the invention, or biocide together with the compound of the invention) in three different concentrations, i.e., 25% v/v, 15% v/v, and 5% v/v, respectively. The concentrations of these ingredients are indicated in FIGS. 1 to 3.

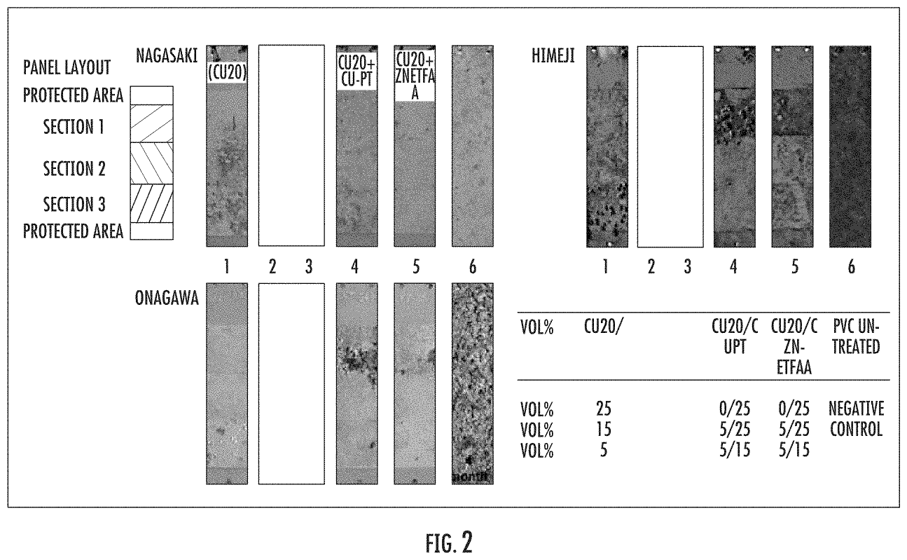

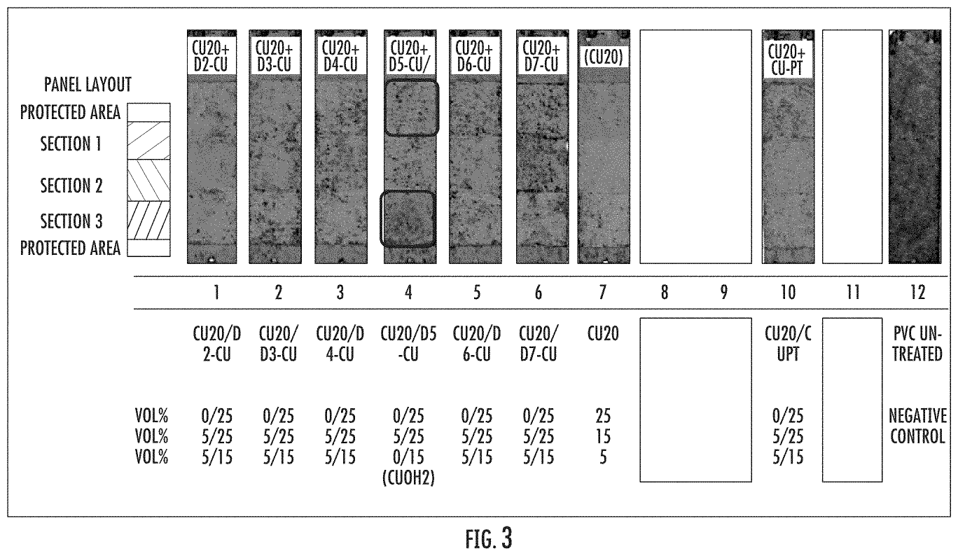

Results: The results after a predefined time (1, 4 or 6 months, as indicated below) immersion in sea water are shown in FIG. 1, FIG. 2 and FIG. 3.

FIG. 1:

Panel 1 depicts a panel painted with a Cu₂O only formulation of an antifouling paint as indicated in table 2 below. The three sections indicate 3 areas on the panel that had been treated with paints containing Cu₂O in different concentrations. The paint applied to section 1 contained 15% v/v of Cu₂O, the paint applied to section 2 of the panel contained 5% v/v of Cu₂O. The last section of panel 1 (emphasized by a square) is a negative control of a painted panel where the paint did not include any antifouling acting ingredient, i.e., neither a biocide nor a compound of formula IA or IB. Panel 6 and Panel 12 in FIG. 1 are negative controls of untreated PVC panels. Panels 2 to 5 and 7 to 10 of FIG. 1 resemble paints containing compounds of formula IA or IB in different concentrations as indicated in FIG. 1.

FIG. 2:

Panel 1 in each of the trials, i.e., in Nagasaki, Himeji and Onagawa, in FIG. 2 is a painted panel with a Cu₂O only formulation of an antifouling paint as indicated in table 3 below. The concentrations of the ingredients comprised in the paints applied to the three sections of the panels are indicated in FIG. 2. Concentrations are in volume % 25, 15, 5. Panel 6 in each trial in FIG. 2 are negative controls of untreated PVC panels. Panel 4 in each trial resembles in section 1 a paint with 25% v/v CuPt, in section 2 a paint with 5% v/v Cu₂O and 25% CuPt, and in section 3 a paint with 5% v/v Cu₂O and 15% v/v CuPt. Panel 5 in each trial resembles in section 1 a paint with 25% v/v ZnETFAA, in section 2 a paint with 5% v/v Cu₂O and 25% ZnETFAA, and in section 3 a paint with 5% v/v Cu₂O and 15% v/v ZnETFAA.

FIG. 3:

Panels 7 and 10 in FIG. 3 are painted with Cu₂O and Cu₂O/CuPT only formulations of an antifouling paint as indicated in table 3 below. Concentrations are in volume % 25, 15, 5. Panel 12 in FIG. 3 is a negative control of an untreated PVC panel. Panels 1 to 6 resemble in section 1 a paint with 25% v/v of the compound of the invention (i.e., panel 1: Der-2-Cu; panel 2: Der-3-Cu; panel 3: Der-4-Cu; panel 4: Der-5-Cu; panel 5: Der-6-Cu; panel 6: Der-7-Cu as indicated in FIG. 3 and in table 1 below); in section 2 a paint with 5% v/v Cu₂O and 25% of the compound of the invention, and in section 3 a paint with 5% v/v Cu₂O and 15% v/v of the compound of the invention.

In comparison to the untreated panel controls and the plain paint controls, all sections of the panels that resemble paints with different concentrations of the compounds of the invention are showing improved antifouling performance. A general trend that all evaluated derivatives are improving the performance of antifouling paints is observed.

TABLE 1
Compounds according to the invention used in example 2:

| Compound | Formula | Me | R1 | R2 | R3 | R4 | R5/R6 |
|---|---|---|---|---|---|---|---|
| ETFAA | IA | | F/F/F | ◯/◯ | ◯ | Ethyl | H/H |
| Zn-ETFAA | IB | Zn | F/F/F | ◯/◯ | ◯ | Ethyl | H/H |
| Ethyl 3-amino-4,4,4- | IA | | F/F/F | NH/◯ | ◯ | Ethyl | H/H |
| trifluorocrotonte | | | | | | | |
| (“Ace”) | | | | | | | |
| DF-Enolether (“DF-E”) | IA | | F/F/H | ◯/◯ | ◯ | Ethyl | ═CH(OEthyl) |
| DFE-Zn | IB | Zn | F/F/H | ◯/◯ | ◯ | Ethyl | ═CH(OEthyl) |
| 4, 4, 4-Trifluoro-N, N- | IB | Cu | F/F/F | ◯/◯ | N | CH3/CH3 | H/H |
| dimethyl-3- | | | | | | | |
| oxobutanamide | | | | | | | |
| “Deriv-2-Cu” | | | | | | | |
| Dodecyl 4, 4, 4-trifluoro- | IB | Cu | F/F/F | ◯/◯ | ◯ | C12H25 | H/H |
| 3-oxobutanoate | | | | | | | |
| “Deriv-3-Cu” | | | | | | | |
| Benzyl 4, 4, 4- | IB | Cu | F/F/F | ◯/◯ | ◯ | Benzyl | H/H |
| trifluoroacetoacetate | | | | | | | |
| “Deriv-4-Cu” | | | | | | | |
| Octyl 4, 4, 4- | IB | Cu | F/F/F | ◯/◯ | ◯ | C8H17 | H/H |
| trifluoroacetoacetate | | | | | | | |
| “Deriv-5-Cu” | | | | | | | |
| Isopropyl 4, 4, 4- | IB | Cu | F/F/F | ◯/◯ | ◯ | iso-propyl | H/H |
| trifluoroacetoacetate | | | | | | | |
| “Deriv-6-Cu” | | | | | | | |
| Tert-Butyl 4, 4, 4- | IB | Cu | F/F/F | ◯/◯ | ◯ | tert-butyl | H/H |
| trifluoro-3-oxobutanoate | | | | | | | |
| “Deriv-7-Cu” | | | | | | | |

TABLE 2
Composition of the paints and control paints:

| | Pos. | Neg. | T10- | T10- | T10- | T10- | T10- | T10- | T10- | T10- | T10- | T10- | T10- | T10- |
|---|---|---|---|---|---|---|---|---|---|---|---|---|---|---|
| Ingredient | control | control | 02 | 03 | 04 | 05 | 06 | 07 | 08 | 09 | 10 | 11 | 12 | 13 |
| Gum Rosin | 10.5 | 9.0 | 9.0 | 9.0 | 9.0 | 9.0 | 9.0 | 9.0 | 9.0 | 9.0 | 9.0 | 9.0 | 9.0 | 9.0 |
| Laroflex | 3.5 | 3.0 | 3.0 | 3.0 | 3.0 | 3.0 | 3.0 | 3.0 | 3.0 | 3.0 | 3.0 | 3.0 | 3.0 | 3.0 |
| MP25 | | | | | | | | | | | | | | |
| Chlor.Paraffin/ | 4.1 | 2.0 | 2.0 | 2.0 | 2.0 | 2.0 | 2.0 | 2.0 | 2.0 | 2.0 | 2.0 | 2.0 | 2.0 | 2.0 |
| Disperbyk161 | | | | | | | | | | | | | | |
| Talc (PKS) | 8.6 | 25.8 | 25.8 | 25.8 | 25.8 | 25.8 | 25.8 | 25.8 | 25.8 | 25.8 | 25.8 | 25.8 | 25.8 | 25.8 |
| Red iron | 1.6 | 3.0 | 3.0 | 3.0 | 3.0 | 3.0 | 3.0 | 3.0 | 3.0 | 3.0 | 3.0 | 3.0 | 3.0 | 3.0 |
| oxide | | | | | | | | | | | | | | |
| Zinc Oxide | 4.9 | 5.0 | 5.0 | 5.0 | 5.0 | 5.0 | 5.0 | 5.0 | 5.0 | 5.0 | 5.0 | 5.0 | 5.0 | 5.0 |
| Cu2O vol % | 36.8 | | | | | | | | | | | | | |
| CuPT | 2.7 | | | | | | | | | | | | | |
| Ace | | | 8.5 | 4.5 | 1.4 | | | | | | | | | |
| DF-E | | | | | | 8.5 | 4.5 | 1.4 | | | | | | |
| DF-P | | | | | | | | | 8.5 | 4.5 | 1.4 | | | |
| ETFAA | | | | | | | | | | | | 8.5 | 4.5 | 1.4 |
| DFE-Zn | | | | | | | | | | | | | | |
| DFE-Zn | | | | | | | | | | | | | | |
| Disparlon | 2.0 | 2.0 | 2.0 | 2.0 | 2.0 | 2.0 | 2.0 | 2.0 | 2.0 | 2.0 | 2.0 | 2.0 | 2.0 | 2.0 |
| A650-20x | | | | | | | | | | | | | | |
| Bentone 38 | 0.4 | 1.0 | 1.0 | 1.0 | 1.0 | 1.0 | 1.0 | 1.0 | 1.0 | 1.0 | 1.0 | 1.0 | 1.0 | 1.0 |
| Xylene | 13.9 | 12.0 | 12.0 | 12.0 | 12.0 | 12.0 | 12.0 | 12.0 | 12.0 | 12.0 | 12.0 | 12.0 | 12.0 | 12.0 |
| (polymer) | | | | | | | | | | | | | | |
| Xylene | 11.1 | 2.8 | 2.8 | 2.8 | 2.8 | 2.8 | 2.8 | 2.8 | 2.8 | 2.8 | 2.8 | 2.8 | 2.8 | 2.8 |
| Total | 100.0 | 65.6 | 74.1 | 70.1 | 67.0 | 74.1 | 70.1 | 67.0 | 74.1 | 70.1 | 67.0 | 74.1 | 70.1 | 67.0 |
| Total | | | | | | | | | | | | | | |
| antifouling | | | | | | | | | | | | | | |
| ingredient | | | | | | | | | | | | | | |
| vol % | 24.9 | 0.0 | 25.0 | 15.0 | 5.0 | 25.0 | 15.0 | 5.0 | 25.0 | 15.0 | 5.0 | 25.0 | 15.0 | 5.0 |
| Cu2O | 20.4 | 0.0 | 0.0 | 0.0 | 0.0 | 0.0 | 0.0 | 0.0 | 0.0 | 0.0 | 0.0 | 0.0 | 0.0 | 0.0 |
| Cu-Pt | 4.5 | 0.0 | 0.0 | 0.0 | 0.0 | 0.0 | 0.0 | 0.0 | 0.0 | 0.0 | 0.0 | 0.0 | 0.0 | 0.0 |
| Ace | 0.0 | 0.0 | 25.0 | 15.0 | 5.0 | 0.0 | 0.0 | 0.0 | 0.0 | 0.0 | 0.0 | 0.0 | 0.0 | 0.0 |
| DF-E | 0.0 | 0.0 | 0.0 | 0.0 | 0.0 | 25.0 | 15.0 | 5.0 | 0.0 | 0.0 | 0.0 | 0.0 | 0.0 | 0.0 |
| DF-P | 0.0 | 0.0 | 0.0 | 0.0 | 0.0 | 0.0 | 0.0 | 0.0 | 25.0 | 15.0 | 5.0 | 0.0 | 0.0 | 0.0 |
| ETFAA | 0.0 | 0.0 | 0.0 | 0.0 | 0.0 | 0.0 | 0.0 | 0.0 | 0.0 | 0.0 | 0.0 | 25.0 | 15.0 | 5.0 |
| DFE-Zn | 0.0 | 0.0 | 0.0 | 0.0 | 0.0 | 0.0 | 0.0 | 0.0 | 0.0 | 0.0 | 0.0 | 0.0 | 0.0 | 0.0 |
| | | | | | | | | | T10- | T10- | T10- | T10- | T10- | T10- |
| | | | | | | | | Ingredient | 14 | 15 | 16 | 17 | 18 | 19 |
| | | | | | | | | Gum Rosin | 9.0 | 9.0 | 9.0 | 9.0 | 9.0 | 9.0 |
| | | | | | | | | Laroflex | 3.0 | 3.0 | 3.0 | 3.0 | 3.0 | 3.0 |
| | | | | | | | | MP25 | | | | | | |
| | | | | | | | | Chlor.Paraffin/ | 2.0 | 2.0 | 2.0 | 2.0 | 2.0 | 2.0 |
| | | | | | | | | Disperbyk161 | | | | | | |
| | | | | | | | | Talc (PKS) | 9.3 | 15.9 | 22.5 | 9.3 | 15.9 | 22.5 |
| | | | | | | | | Red iron | 3.0 | 3.0 | 3.0 | 3.0 | 3.0 | 3.0 |
| | | | | | | | | oxide | | | | | | |
| | | | | | | | | Zinc Oxide | 5.0 | 5.0 | 5.0 | 5.0 | 5.0 | 5.0 |
| | | | | | | | | Cu2O vol % | | | | | | |
| | | | | | | | | CuPT | | | | | | |
| | | | | | | | | Ace | | | | | | |
| | | | | | | | | DF-E | | | | | | |
| | | | | | | | | DF-P | | | | | | |
| | | | | | | | | ETFAA | | | | | | |
| | | | | | | | | DFE-Zn | 11.5 | 6.9 | 2.3 | | | |
| | | | | | | | | DFE-Zn | | | | 11.5 | 6.9 | 2.3 |
| | | | | | | | | Disparlon | 2.0 | 2.0 | 2.0 | 2.0 | 2.0 | 2.0 |
| | | | | | | | | A650-20x | | | | | | |
| | | | | | | | | Bentone 38 | 1.0 | 1.0 | 1.0 | 1.0 | 1.0 | 1.0 |
| | | | | | | | | Xylene | 12.0 | 12.0 | 12.0 | 12.0 | 12.0 | 12.0 |
| | | | | | | | | (polymer) | | | | | | |
| | | | | | | | | Xylene | 8.3 | 8.3 | 8.3 | 8.3 | 8.3 | 8.3 |
| | | | | | | | | Total | 66.1 | 68.1 | 70.1 | 66.1 | 68.1 | 70.1 |
| | | | | | | | | Total | | | | | | |
| | | | | | | | | antifouling | | | | | | |
| | | | | | | | | ingredient | | | | | | |
| | | | | | | | | vol % | 25.0 | 15.0 | 5.0 | 0.0 | 0.0 | 0.0 |
| | | | | | | | | Cu2O | 0.0 | 0.0 | 0.0 | 0.0 | 0.0 | 0.0 |
| | | | | | | | | Cu-Pt | 0.0 | 0.0 | 0.0 | 0.0 | 0.0 | 0.0 |
| | | | | | | | | Ace | 0.0 | 0.0 | 0.0 | 0.0 | 0.0 | 0.0 |
| | | | | | | | | DF-E | 0.0 | 0.0 | 0.0 | 0.0 | 0.0 | 0.0 |
| | | | | | | | | DF-P | 0.0 | 0.0 | 0.0 | 0.0 | 0.0 | 0.0 |
| | | | | | | | | ETFAA | 0.0 | 0.0 | 0.0 | 0.0 | 0.0 | 0.0 |
| | | | | | | | | DFE-Zn | 25.0 | 15.0 | 5.0 | 25.0 | 15.0 | 5.0 |

TABLE 3
Composition of the paints and control paints:

| | positive | T11- | T11- | T11- | T11- | T11- | T11- | T11- | T11- | T11- |
|---|---|---|---|---|---|---|---|---|---|---|
| Ingredient | control | 01 | 02 | 03 | 10 | 11 | 12 | 13 | 14 | 15 |
| Gum Rosin | 10.5 | 9.0 | 9.0 | 9.0 | 9.0 | 9.0 | 9.0 | 9.0 | 9.0 | 9.0 |
| Laroflex MP25 | 3.5 | 3.0 | 3.0 | 3.0 | 3.0 | 3.0 | 3.0 | 3.0 | 3.0 | 3.0 |
| Chlorinated Paraffin/Disperbyk161 | 4.1 | 2.0 | 2.0 | 2.0 | 2.0 | 2.0 | 2.0 | 2.0 | 2.0 | 2.0 |
| Talc (PKS) | 8.6 | 9.2 | 15.6 | 21.8 | 9.3 | 6.0 | 12.6 | 9.3 | 6.0 | 12.6 |
| Red iron oxide | 1.6 | 3.0 | 3.0 | 3.0 | 3.0 | 3.0 | 3.0 | 3.0 | 3.0 | 3.0 |
| Zinc Oxide | 4.9 | 5.2 | 5.8 | 6.5 | 5.2 | 4.8 | 5.4 | 5.2 | 4.8 | 5.4 |
| Cu2O vol % | 36.8 | 38.2 | 22.9 | 7.7 | | 7.7 | 7.7 | | 7.7 | 7.7 |
| CuPT | 2.7 | | | | 11.5 | 11.5 | 6.9 | | | |
| Zn-ETFAA | | | | | | | | 11.5 | 11.5 | 6.9 |
| Disparlon A650-20x | 2.0 | 2.0 | 2.0 | 2.0 | 2.0 | 2.0 | 2.0 | 2.0 | 2.0 | 2.0 |
| Bentone 38 | 0.4 | 1.0 | 1.0 | 1.0 | 1.0 | 1.0 | 1.0 | 1.0 | 1.0 | 1.0 |
| Xylene (polymer) | 13.9 | 12.0 | 12.0 | 12.0 | 12.0 | 12.0 | 12.0 | 12.0 | 12.0 | 12.0 |
| Xylene | 11.1 | 16.8 | 13.3 | 9.7 | 5.4 | 7.1 | 8.2 | 5.4 | 7.2 | 8.2 |
| Xylene (additional) | 0.0 | 3.0 | 7.0 | 5.0 | 6.0 | 6.0 | 6.0 | 3.0 | 3.0 | 3.0 |
| Total | 100.0 | 104.4 | 96.6 | 82.7 | 69.4 | 75.1 | 78.8 | 66.4 | 72.2 | 75.8 |
| Total antifouling | 25.3 | 25.0 | 15.0 | 5.0 | 25.0 | 30.1 | 20.0 | 25.0 | 30.1 | 20.0 |
| ingredient vol % | | | | | | | | | | |
| Cu2O vol % | 20.3 | 25.0 | 15.0 | 5.0 | 0.0 | 5.0 | 5.0 | 0.0 | 5.0 | 5.0 |
| Cu-Pt vol % | 5.0 | 0.0 | 0.0 | 0.0 | 25.0 | 25.0 | 15.0 | 0.0 | 0.0 | 0.0 |
| Zn-EtFAA vol % | 0.0 | 0.0 | 0.0 | 0.0 | 0.0 | 0.0 | 0.0 | 25.0 | 25.0 | 15.0 |
| Total antifouling | 66.4 | 53.8 | 36.5 | 14.2 | 25.8 | 39.6 | 28.6 | 25.8 | 39.6 | 28.6 |
| ingredient wt % | | | | | | | | | | |
| Cu2O wt % | 61.8 | 53.8 | 36.5 | 14.2 | 0.0 | 15.9 | 15.1 | 0.0 | 15.9 | 15.1 |
| Cu-Pt wt % | 4.5 | 0.0 | 0.0 | 0.0 | 25.8 | 23.7 | 13.5 | 0.0 | 0.0 | 0.0 |
| Zn-EtFAA wt % | 0.0 | 0.0 | 0.0 | 0.0 | 0.0 | 0.0 | 0.0 | 25.8 | 23.7 | 13.5 |

TABLE 4
Composition of the paints and control paint:

| | positive | | | | | | | | | | | |
|---|---|---|---|---|---|---|---|---|---|---|---|---|
| ingredient | control | | | | | | | | | | | |
| Gum Rosin | 10.5 | 9.0 | 9.0 | 9.0 | 9.0 | 9.0 | 9.0 | 9.0 | 9.0 | 9.0 | 9.0 | 9.0 |
| Laroflex | 3.5 | 3.0 | 3.0 | 3.0 | 3.0 | 3.0 | 3.0 | 3.0 | 3.0 | 3.0 | 3.0 | 3.0 |
| MP25 | | | | | | | | | | | | |
| Chlorinated | 4.1 | 2.0 | 2.0 | 2.0 | 2.0 | 2.0 | 2.0 | 2.0 | 2.0 | 2.0 | 2.0 | 2.0 |
| Paraffin/ | | | | | | | | | | | | |
| Disperbyk161 | | | | | | | | | | | | |
| Talc (PKS) | 8.6 | 9.2 | 6.1 | 12.4 | 9.2 | 6.1 | 12.4 | 9.2 | 6.1 | 12.4 | 9.2 | 6.1 |
| Red iron | 1.6 | 3.0 | 3.0 | 3.0 | 3.0 | 3.0 | 3.0 | 3.0 | 3.0 | 3.0 | 3.0 | 3.0 |
| oxide | | | | | | | | | | | | |
| Zinc Oxide | 4.9 | 5.2 | 4.8 | 5.4 | 5.2 | 4.8 | 5.4 | 5.2 | 4.8 | 5.4 | 5.2 | 4.8 |
| Cu2O | 36.8 | | 7.7 | 7.7 | | 7.7 | 7.7 | | 7.7 | 7.7 | | 7.7 |
| CuPT | 2.7 | | | | | | | | | | | |
| Deriv-2-Cu | | 11.5 | 11.5 | 6.9 | | | | | | | | |
| Deriv-3-Cu | | | | | 11.5 | 11.5 | 6.9 | | | | | |
| Deriv-4-Cu | | | | | | | | 11.5 | 11.5 | 6.9 | | |
| Deriv-5-Cu | | | | | | | | | | | 11.5 | 11.5 |
| Deriv-6-Cu | | | | | | | | | | | | |
| Deriv-7-Cu | | | | | | | | | | | | |
| Deriv-6-zn | | | | | | | | | | | | |
| Deriv-7-Zn | | | | | | | | | | | | |
| Disparlon | 2.0 | 2.0 | 2.0 | 2.0 | 2.0 | 2.0 | 2.0 | 2.0 | 2.0 | 2.0 | 2.0 | 2.0 |
| A650-20x | | | | | | | | | | | | |
| Bentone 38 | 0.4 | 1.0 | 1.0 | 1.0 | 1.0 | 1.0 | 1.0 | 1.0 | 1.0 | 1.0 | 1.0 | 1.0 |
| Xylene | 13.9 | 12.0 | 12.0 | 12.0 | 12.0 | 12.0 | 12.0 | 12.0 | 12.0 | 12.0 | 12.0 | 12.0 |
| (polymer) | | | | | | | | | | | | |
| Xylene | 11.1 | 5.4 | 7.2 | 8.2 | 5.4 | 7.2 | 8.2 | 5.4 | 7.2 | 8.2 | 5.4 | 7.2 |
| Xylene | | 0.0 | 0.0 | 0.0 | 8.6 | 4.3 | 6.4 | 4.3 | 4.3 | 4.3 | 4.3 | 2.1 |
| (additional) | | | | | | | | | | | | |
| Total | 100.0 | 63.3 | 69.3 | 72.6 | 71.8 | 73.5 | 79.0 | 67.5 | 73.5 | 76.8 | 67.5 | 71.4 |
| Total | 25.3 | 25.0 | 30.0 | 20.0 | 25.0 | 30.0 | 20.0 | 25.0 | 30.0 | 20.0 | 25.0 | 30.0 |
| antifouling | | | | | | | | | | | | |
| ingredient | | | | | | | | | | | | |
| vol% | | | | | | | | | | | | |
| Cu2O vol % | 20.3 | 0.0 | 5.0 | 5.0 | 0.0 | 5.0 | 5.0 | 0.0 | 5.0 | 5.0 | 0.0 | 5.0 |
| Cu-Pt vol % | 5.0 | 0.0 | 0.0 | 0.0 | 0.0 | 0.0 | 0.0 | 0.0 | 0.0 | 0.0 | 0.0 | 0.0 |
| Deriv vol % | 0.0 | 25.0 | 25.0 | 15.0 | 25.0 | 25.0 | 15.0 | 25.0 | 25.0 | 15.0 | 25.0 | 25.0 |
| Total | | | | | | | | | | | | |
| antifouling | | | | | | | | | | | | |
| ingredient | | | | | | | | | | | | |
| wt % | 53.8 | 25.9 | 39.5 | 28.7 | 25.9 | 39.5 | 28.7 | 25.9 | 39.5 | 28.7 | 25.9 | 39.5 |
| Cu2O wt % | 50.1 | 0.0 | 15.9 | 15.2 | 0.0 | 15.9 | 15.2 | 0.0 | 15.9 | 15.2 | 0.0 | 15.9 |
| Cu-Pt wt % | 3.7 | 0.0 | 0.0 | 0.0 | 0.0 | 0.0 | 0.0 | 0.0 | 0.0 | 0.0 | 0.0 | 0.0 |
| Deriv wt % | 0.0 | 25.9 | 23.6 | 13.5 | 25.9 | 23.6 | 13.5 | 25.9 | 23.6 | 13.5 | 25.9 | 23.6 |
| | | | | | ingredient | | | | | | | |
| | | | | | Gum Rosin | 9.0 | 9.0 | 9.0 | 9.0 | 9.0 | 9.0 | 9.0 |
| | | | | | Laroflex | 3.0 | 3.0 | 3.0 | 3.0 | 3.0 | 3.0 | 3.0 |
| | | | | | MP25 | | | | | | | |
| | | | | | Chlorinated | 2.0 | 2.0 | 2.0 | 2.0 | 2.0 | 2.0 | 2.0 |
| | | | | | Paraffin/ | | | | | | | |
| | | | | | Disperbyk161 | | | | | | | |
| | | | | | Talc (PKS) | 12.4 | 9.2 | 6.1 | 12.4 | 9.2 | 6.1 | 12.4 |
| | | | | | Red iron | 3.0 | 3.0 | 3.0 | 3.0 | 3.0 | 3.0 | 3.0 |
| | | | | | oxide | | | | | | | |
| | | | | | Zinc Oxide | 5.4 | 5.2 | 4.8 | 5.4 | 5.2 | 4.8 | 5.4 |
| | | | | | Cu2O | 7.7 | | 7.7 | 7.7 | | 7.7 | 7.7 |
| | | | | | CuPT | | | | | | | |
| | | | | | Deriv-2-Cu | | | | | | | |
| | | | | | Deriv-3-Cu | | | | | | | |
| | | | | | Deriv-4-Cu | | | | | | | |
| | | | | | Deriv-5-Cu | 6.9 | | | | | | |
| | | | | | Deriv-6-Cu | | 11.5 | 11.5 | 6.9 | | | |
| | | | | | Deriv-7-Cu | | | | | 11.5 | 11.5 | 6.9 |
| | | | | | Deriv-6-zn | | | | | | | |
| | | | | | Deriv-7-Zn | | | | | | | |
| | | | | | Disparlon | 2.0 | 2.0 | 2.0 | 2.0 | 2.0 | 2.0 | 2.0 |
| | | | | | A650-20x | | | | | | | |
| | | | | | Bentone 38 | 1.0 | 1.0 | 1.0 | 1.0 | 1.0 | 1.0 | 1.0 |
| | | | | | Xylene | 12.0 | 12.0 | 12.0 | 12.0 | 12.0 | 12.0 | 12.0 |
| | | | | | (polymer) | | | | | | | |
| | | | | | Xylene | 8.2 | 5.4 | 7.2 | 8.2 | 5.4 | 7.2 | 8.2 |
| | | | | | Xylene | | 4.3 | 4.3 | 4.3 | 8.6 | 6.4 | 6.4 |
| | | | | | (additional) | | | | | | | |
| | | | | | Total | 72.6 | 67.5 | 73.5 | 76.8 | 71.8 | 75.7 | 79.0 |
| | | | | | Total | 20.0 | 25.0 | 30.0 | 20.0 | 25.0 | 30.0 | 20.0 |
| | | | | | antifouling | | | | | | | |
| | | | | | ingredient | | | | | | | |
| | | | | | vol% | | | | | | | |
| | | | | | Cu2O vol % | 5.0 | 0.0 | 5.0 | 5.0 | 0.0 | 5.0 | 5.0 |
| | | | | | Cu-Pt vol % | 0.0 | 0.0 | 0.0 | 0.0 | 0.0 | 0.0 | 0.0 |
| | | | | | Deriv vol % | 15.0 | 25.0 | 25.0 | 15.0 | 25.0 | 25.0 | 15.0 |
| | | | | | Total | | | | | | | |
| | | | | | antifouling | | | | | | | |
| | | | | | ingredient | | | | | | | |
| | | | | | wt % | 28.7 | 25.9 | 39.5 | 28.7 | 25.9 | 39.5 | 28.7 |
| | | | | | Cu2O wt % | 15.2 | 0.0 | 15.9 | 15.2 | 0.0 | 15.9 | 15.2 |
| | | | | | Cu-Pt wt % | 0.0 | 0.0 | 0.0 | 0.0 | 0.0 | 0.0 | 0.0 |
| | | | | | Deriv wt % | 13.5 | 25.9 | 23.6 | 13.5 | 25.9 | 23.6 | 13.5 |

1. An antifouling composition comprising a compound of formula IA and/or IB 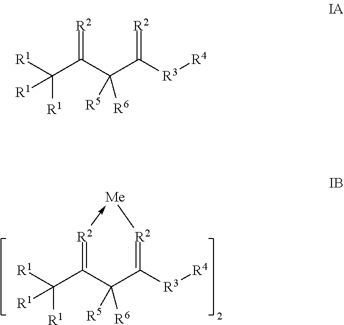
wherein
Me represents metal, preferably Cu, Zn, Co, Ni, Ca, Mg or Mn;
R1 is each independently selected from hydrogen, halogen, linear or branched C₁₋₂₀ alkyl, C₂₋₂₀ alkenyl, C₂₋₂₀ alkynyl, C₃₋₁₂ cycloalkyl, C₆₋₂₀ aryl and C₇₋₂₀ arylalkyl;
R2 is each independently selected from NH, O, S, and Se;
R3 is NH, N(R4), O, S, and Se;
R4 is hydrogen, linear or branched C₁₋₂₀ alkyl, C₂₋₂₀ alkenyl, C₂₋₂₀ alkynyl, C₃₋₁₂ cycloalkyl, C₆₋₂₀ aryl, C₇₋₂₀ arylalkyl;
R5 and R6 are each independently selected from H, linear or branched C₁₋₂₀ alkyl, C₂₋₂₀ alkenyl, C₂₋₂₀ alkynyl, C₃₋₁₂ cycloalkyl, C₆₋₂₀ aryl and C₇₋₂₀ arylalkyl; or
R5 and R6 together form a group ═O, ═S, ═Se, ═NR4, ═C(R4)₂, ═C(R4)(OR4), ═C(R4)(NHR4).

2. The antifouling composition of claim 1, wherein in said compound of formula IA and/or IB
Me represents Cu, Zn, Ca, Mg or Mn;
R1 is each independently selected from H, F, Cl, Br, I, linear or branched C₁₋₁₂ alkyl, C₂₋₁₂ alkenyl, C₂₋₁₂ alkynyl, C₆₋₁₂ aryl, and C₇₋₁₂ arylalkyl;
R2 is each independently selected from NH, 0, and S;
R3 is NH, N(R4), 0, and S;
R4 is H, linear or branched C₁₋₁₂ alkyl, C₂₋₁₂ alkenyl, C₂₋₁₂ alkynyl, C₃₋₈ cycloalkyl, C₆₋₁₂ aryl, C₇₋₁₂ arylalkyl;
R5 and R6 are each independently selected from H, linear or branched C₁₋₄ alkyl, C₂₋₄ alkenyl, C₂₋₄ alkynyl, C₃₋₆ cycloalkyl, C₆₋₁₂ aryl and C₇₋₁₂ arylalkyl; or
R5 and R6 together form a group ═O, ═S, ═NR4, ═C(R4)₂, ═C(R4)(OR4), ═C(R4)(NHR4).

3. The antifouling composition of claim 1, wherein in said compound of formula IA and/or IB
Me represents Cu or Zn;
R1 is each independently selected from H, F, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, alkyl, C₁₂ alkyl, and benzyl;
R2 is each independently selected from NH, and O;
R3 is N(R4) and O;
R4 is H, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, and benzyl;
R5 and R6 are each independently selected from H, methyl, ethyl, n-propyl, propyl, n-butyl, i-butyl, tert-butyl, and benzyl; or
R5 and R6 together form a group ═CH(OCH₃); ═CH(OC₂H₅); ═CH(OnC₃H₇); ═CH(OiC₃H₇); ═CH(OnC₄H₉); ═CH(OiC₄H₉); ═CH(OtertC₄H₉), ═CH(NHCH₃); ═CH(NHC₂H₅); ═CH(NHnC₃H₇); ═CH(NHiC₃H₇); ═CH(NHnC₄H₉); ═CH(NHiC₄H₉); ═CH(NHtertC₄H₉);

4. The antifouling composition of claim 1, wherein the one or more biocidal agent is selected from the group consisting of copper 2-pyridinethiol-1-oxide (copper pyrithione, CuPT), zinc 2-pyridinethiol-1-oxide (zinc pyrithione, ZnPT), 4,5-dichloro-2-n-octyl-4-isothiazolin-3-one (DCOIT), cuprous oxide (Cu₂O), zinc oxide (ZnO), 4-bromo-2-(4-chlorophenyl)-5-(trifluoromethyl)-1H-pyrrole-3-carbonitrile (tralopyril), zinc ethane-1,2-diylbis(dithiocarbamate) (zineb), zinc N,N-dimethylcarbamodithioate (ziram), 3-(3,4-dichlorophenyl)-1,1-dimethylurea (diuron), copper(I) thiocyanate (CuSCN), 4-[1-[2,3-dimethylphenyl)ethyl]-1H-imidazole (medetomidine), triazines, fluanids and 2,4,5,6-tetrachloroisophthalonitrile (chlorothalonil).

5. The antifouling composition of claim 1, wherein the one or more biocidal agent is selected from the group consisting of CuPT, ZnPT, DCOIT, Cu₂O, and tralopyril.

6. The antifouling composition of claim 1, wherein the one or more biocidal agent is selected from the group consisting of CuPT and Cu₂O.

7. The antifouling composition of claim 6, wherein the ratio of the compound of formula IA and/or IB (wt %) to CuPT (wt %), and/or the ratio of compound of formula IA and/or IB (wt %) to Cu₂O (wt %) is from 100:1 to 1:100.

8. Use of an antifouling composition of claim 1 for the inhibition of marine biofouling on a solid surface.

9. The use of claim 8, wherein the antifouling composition is used in combination with a polymer and/or copolymer allowing controlled release of compound of formula IA and/or IB.

10. An antifouling paint comprising the antifouling composition of claim 1 and a polymer and/or copolymer allowing controlled release of compound of formula IA and/or IB.

11. The antifouling paint of claim 10, wherein the content of compound of formula IA and/or IB is from about 1 to about 25 wt %.

12. The antifouling paint of claim 1, wherein the total content of said one or more biocidal agent is less than about 30 wt %.

13. The antifouling paint of claim 1, wherein the total content of CuPT is less than about 10 wt %.

14. A method for inhibiting marine biofouling on a solid surface, comprising applying an antifouling paint of claim 1 onto said surface.
